(19) United States
(12) Patent Application Publication
(10) Pub. No.: US 2003/0231194 A1
(43) Pub. Date: Dec. 18, 2003

(54) Histogram method for image-adaptive bit-sequence selection for modulated displays

(75) Inventors: Daniel J. Morgan, Denton, TX (US); Jeffrey S. Farris, Flower Mound, TX (US)

Correspondence Address: TEXAS INSTRUMENTS INCORPORATED, P O BOX 655474, M/S 3999, DALLAS, TX, 75265

(73) Assignee: Texas Instruments Inc.

(21) Appl. No.: 10/443,415

(22) Filed: May 22, 2003

Related U.S. Application Data
(60) Provisional application No. 60/388,529, filed on Jun. 13, 2002.

(51) Int. Cl. G09G 5/10

(52) U.S. Cl. 345/691

(57) ABSTRACT

The present application describes a system and method for selecting the best modulation sequence for an image (e.g., video, graphics or the like) on a frame-by-frame basis to optimize the system contrast ratio, brightness and black level based on a histogram of pixels in each frame. Embodiments described in this application include Pulse-Width Modulation (PWM) display systems such as DMD™. In an embodiment, the present invention uses the histogram of pixels in each frame of an image to select alternate color sequences for each frame of the image wherein the alternative color sequence includes reduced number of bits for color representations than the original color sequence.

### CROSS-REFERENCE TO RELATED APPLICATION

The present application claims priority from U.S. Provisional Application entitled “Histogram Method For Image-Adaptive Bit-Sequence Selection For Modulated Displays,” Ser. No. 60/388,529, filed Jun. 13, 2002, having Daniel J. Morgan and Jeffrey S. Farris as inventors, and having as assignee Texas Instruments Inc., the assignee of the present application. This provisional application is incorporated herein by reference in its entirety for all purposes.

### BACKGROUND

The present application describes image-adaptive systems and methods for improving display performance in modulated display systems.

When a PWM modulated display system, such as a Digital Mirror Display (DMD™)-based display system, displays an image (e.g., graphics, video or the like), each pixel is switched between “on” and “off’ many times during a display frame. These transitions, although very fast, are not instantaneous. During the time that the switching device is transitioning, the light is neither being used in its proper location on the screen, nor is it sent entirely to the “light dump”—a safe place where light can go without ricocheting onto the screen through the optics. Imperfect control of the light bundle during these modulator transitions causes both the image black level to increase (from scattered light during transition sweeps), and the maximum white level to decrease (from light not aimed at the screen when it could have been), leading to a reduction in overall image contrast ratio and brightness from the ideal case.

For an all-black or all-white image on the DMD, there are still reductions in brightness and contrast ratio. This is because when the reset signal is applied to the DMD, causing the mirrors to change states, the mirrors can break loose and move slightly, even if for a particular mirror during the reset period of the DMD the data says that it should stay in its current state. The operating electrostatic forces cause this to occur. For an all-black screen, the mirrors can break loose thus moving slightly away from the full OFF state and scatter more light into the optics. This raises the black level and thus reduces the contrast ratio. Similarly, in an all-white screen, when the mirrors move slightly from the full ON state, a slight reduction in screen brightness occurs, which again is a departure from the ideal.

One possible solution for the loss of brightness and contrast due to modulator transitions is to switch modulator states less frequently, such as only once per image update frame. For images containing gray shades (or mid-level colors), it may not be possible to reduce the frequency of modulator switching and maintain an acceptable image. When the image predominantly contains pixels that are nearly full-scale white or nearly full-scale black (including images that are a mixture of near-full-scale white and near-full-scale black pixels), it is possible to display an accurate image with only a single modulator transition per display frame—a single modulator transition sequence. This allows the display system to operate at the optical system limits of contrast ratio, brightness (or screen lumens), and black level. However, using a single modulator transition sequence per frame causes problems even with a near-full-scale black-and-white image when the image suddenly changes to a gray-shaded or colored image. In such case, if the image on the screen continues to be rendered in full-scale black and white, an unpleasant image anomaly is created.

For color images, a single modulator transition over a frame period generally, cannot be used as described above, to improve the brightness and contrast and achieve certain color levels, although it is possible to apply the principles described in the black-and-white embodiments in the color context. For example, in addition to the brightness and contrast penalties due to mirror transitions, color images also include “short bits” i.e., the least significant bits (LSBs) of the data word for the color sequence can include short on-times that require special timing operations. These special timing operations add additional brightness and contrast penalty.

Examples of these LSB special timings for color images are “'Reset and Release bits” and “'Fast Clear bits.” Reset and Release bits have the mirrors reside in the flat state for some period of time during which the LSB is applied for each color. This gives a lumens loss and also a significant contrast penalty because the flat state of the mirrors reflect considerably more stray light onto the screen than do the mirrors' the OFF states. The Fast Clear types of LSBs do not use the mirror flat states, but instead have mandatory OFF state times each time an LSB is applied. This affects screen brightness (lumens) because the mirrors are always off during each frame for some amount of time.

Both types of LSB special timings diminish the display brightness and contrast ratio because the white level is reduced. The Reset and Release bits affect both the black and white levels, while the Fast Clear bits affect only the white level. Accordingly, a system and method is needed to select proper modulation sequence on a frame-by-frame basis to fully optimize system contrast ratio, brightness, and black level and to select reduced bit image resolution per color sequence for color images.

### SUMMARY

The present application describes a system and method for selecting the best modulation sequence for an image (e.g., video, graphics or the like) on a frame-by-frame basis to optimize the system contrast ratio, brightness and black level based on a histogram of pixels in each frame. Embodiments described in this application include Pulse-Width Modulation (PWM) display systems such as DMD™. In some color images, the LSB special timings are not needed. These LSB special timings can be avoided for images where localized contiguous areas of pixels having dark details must be displayed. Typical computer images such as those viewed in an office environment do no have areas having very dark shades of colors. Thus the LSBs in each color can be reduced for many typical color images that are displayed. For example, in a given color image, 7-bit color sequence for each pixel can often be used instead of 8-bit color sequence. In an embodiment, the present invention uses the histogram of pixels in each frame of an image to select alternate color sequences for each frame of the image wherein the alternative color sequence includes reduced number of bits for color representations than the original color sequence.

In an embodiment, the present invention describes a method of processing an image, the image including a sequence of frames of pixels. The method includes determining the numbers of substantially dark and substantially light pixels for one or more frames of the sequence of frames and selecting a pulse-width modulation sequence for the one or more frames based at least partially on the number of particular pixels in the corresponding frame. In some variations, the number of pixels is determined using a histogram of the pixels in the corresponding frame. In some embodiments, the pulse-width modulation sequence is one or more of a single modulator transition (single pixel value update) and multi-modulator transition (multiple pixel value update). In some variations of the invention, the pulse-width modulation sequence for a first frame is selected prior to processing a second frame that immediately follows the first frame in the sequence of frames based at least partially on the number of particular pixels in the first frame.

In some embodiments, the pulse-width modulation sequence for a particular frame of the sequence of frames is selected based at least partially on a predetermined number of substantially dark versus substantially light pixels in the particular frame. In some variations, the method includes delaying the selection of the pulse-width modulation sequence for a predetermined period upon determining the number of substantially dark and substantially light pixels in the one or more frames.

In some embodiments, the present invention describes a method of processing an image, the image including one or more frames corresponding to a first color sequence, the method includes determining a number of groups of pixels in the one or more frames, wherein each one of the pixels correspond to a pixel code and if the one or more frames include a predetermined number of the groups of pixels, selecting a second color sequence for the one or more frames. In some variations, each one of the groups of pixels include a multiple of adjacent pixels and each one of the multiple of adjacent pixels corresponds to at least one pixel code from a predetermined range of pixel codes. In some embodiments, the range of pixel codes is predetermined for each group. In some variations, the pixel codes correspond to respective color shade of each pixel in the image. In some embodiments, the number of pixels in each group is predetermined. In some variations, the pixels in the respective groups are one or more of horizontally, vertically and diagonally adjacent pixels.

In some variations, the second color sequence is selected according to the number of groups of pixels in the one or more frames. In some embodiments, color representations in the second color sequence are at least one bit less than corresponding color representations in the first color sequence. In some variations, the first color sequence includes at least eight-bits color representation and the second color sequence includes less than eight-bits representations for corresponding colors. In some variations, the number of groups of pixels in the one or more frames is determined using a histogram of pixels for the corresponding frames.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The embodiments of the present invention may be better understood, and its numerous objects, features, and advantages made apparent to those skilled in the art by referencing the accompanying drawings.

FIGS. 1A-1C illustrate reflected light paths from a DMD pixel at its “ON,” “OFF,” and “FLAT” states, respectively according to an embodiment of the present invention.

FIG. 2 is a block diagram of an exemplary display system according to an embodiment of the present invention.

FIG. 3 is detailed block diagram of circuitry to monitor the images being displayed and to change the reset mode being employed for the updating of pixel values in the display system according to an embodiment of the present invention.

FIG. 4 is a diagram illustrating exemplary trigger points at which the reduced resets can be enabled or disabled according to an embodiment of the present invention.

All of these drawings are drawings of certain embodiments. The scope of the claims is not to be limited to the specific embodiments illustrated in the drawings and described below. The use of the same reference symbols in different drawings indicates similar or identical items.

### DETAILED DESCRIPTION OF THE EMBODIMENTS

A few preferred embodiments have been described in detail herein. It is to be understood that the scope of the invention also comprehends embodiments different from those described, yet within the scope of the claims. Words of inclusion are to be interpreted as nonexhaustive in considering the scope of the invention. While this invention has been described with reference to illustrative embodiments, this description, is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

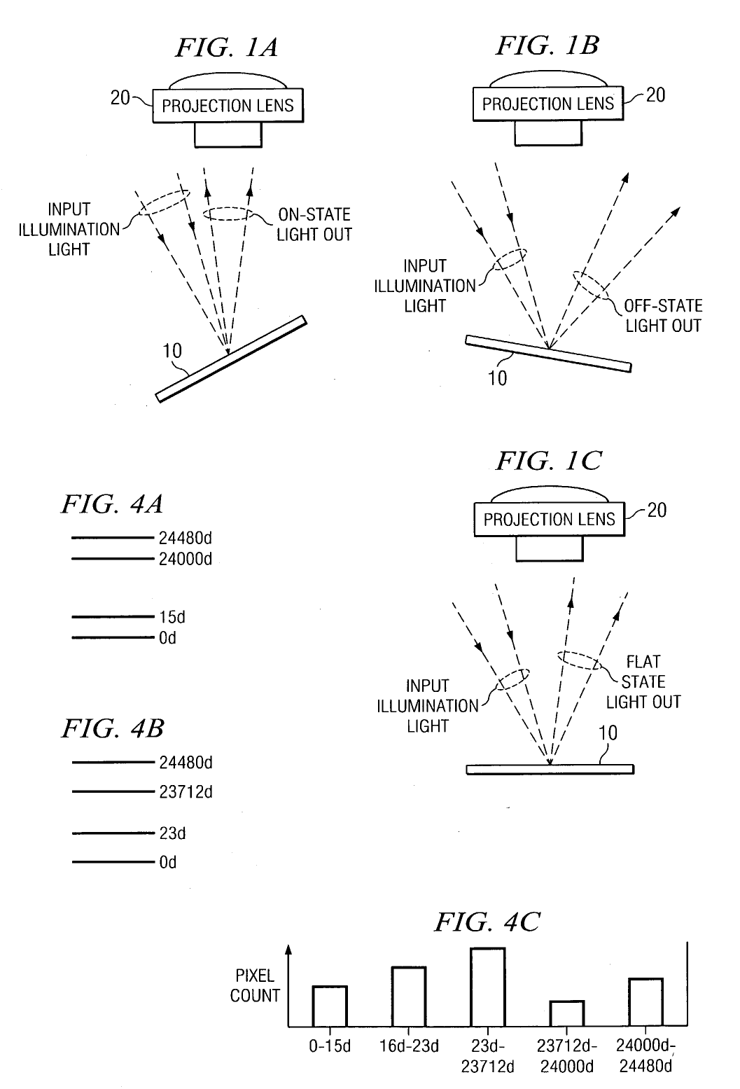

FIGS. 1A-1C illustrate reflected light paths from a DMD pixel at its “ON,” “OFF,” and “FLAT” states, respectively according to an embodiment of the present invention. In FIG. 1A, a pixel 10 is in its “ON” state and accordingly reflects a high percentage of the input illumination light into a projection lens 20. In FIG. 1B, pixel 10 is in its “OFF” state, and accordingly reflects a high percentage of the input illumination light away from projection lens 20. In FIG. 1C, pixel 10 is in its “FLAT” or transitional state. The FLAT state inherently subtracts from times where the pixel can either be full on or full off, and accordingly limits the contrast ratio, brightness, and darkness limits.

In DMD and other digital display systems, light is typically displayed as a function of digital pixel codes. These pixel codes determine how long a pixel is to be “on” during a certain period. For an 8-bit code, ‘0’ represents no light, ‘255’ (binary ‘1111 1111’) represents peak light and 127 (binary ‘0111 1111’) represents mid-scale light. Codes between 0 and 255 form a gray scale or define the brightness in each of the typically three colors that are combined to generate a full-color image. The size of this gray scale (e.g., the number of levels) set the image bit-depth resolution for the system by defining the number of discrete levels of light that can be produced for each color. Thus, in general, a code of “0” indicates that the pixel should be “off” for the entire period, while a code of “255” indicates that the pixel should be “on” for the entire period. The codes between ‘0’ and ‘255’ can correspond in a linear, exponential, or other function to the “on” time or duty cycle for pixel 10.

There are different modulation schemes for translating the digital pixel codes into values (e.g., the “on” times) for the corresponding pixels 10. Certain Pulse Width Modulation (“PWM”) schemes, for example, modulate the mirrors as powers of 2. For example 20 us (00000001), 40 us (00000010), 80 us (00000100), 160 us (00001000), 320 us (00010000), 640 us (00100000), 1280 us (01000000), 2560 us (10000000) could be used to define the mirror on-times for the 8 bit-planes needed for 8-bit video where 5.0 ms is available per color. Intermediate values in steps of 20 us can be used. For example, 100 us would be represented in this scheme as 00000101, and 120 us would be represented by 00000110. The light is transmitted to the display screen as black for the bit plane of pixel 10, which is logic 0, or at full brightness during a bit plane which is logic 1. Since the “on” times for bit-planes vary, this results in modulated light over a frame period. Viewers' eyes integrate the modulated light so that gray levels are formed.

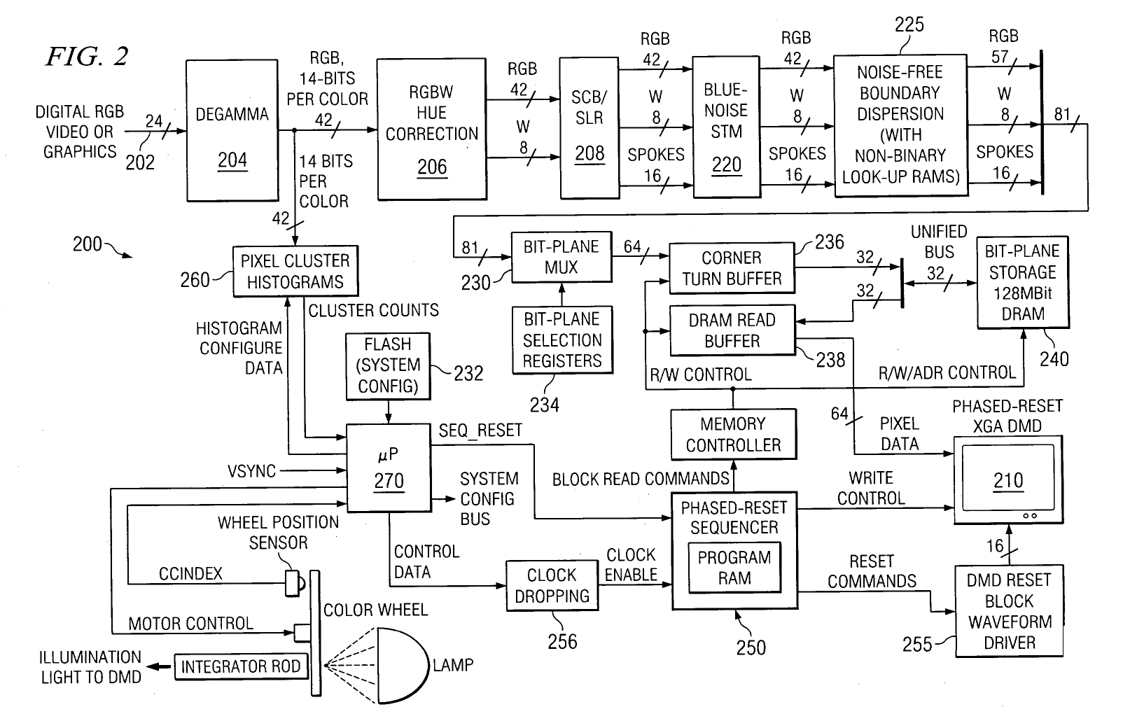

FIG. 2 is a block diagram of an exemplary display system 200 according to an embodiment of the present invention. An input 202 to system 200 is an RGB (Red-Green-Blue) 24-bit image signal (e.g., motion video, still graphics or the like). The input is received by a degamma circuit 204. According to an embodiment, degamma circuit 204 is a degamma RAM look-up table. degamma circuit 204 provides correction of brightness/voltage (i.e., the gamma correction). The gamma correction is generally included in the image signal. Typically, a linear device, such as a DMD device 210, removes or ‘degammas’ the incoming signal to compensate for the inclusion of this gamma information.

The output of degamma circuit 204 is extended to 14 bits per color, to allow for the displaying of dark color shades on DMD 210. degamma circuit 204 “gains down” or lowers the gain on the lower codes, which makes for fractional bits if the degamma output is looked at on a 8-bit scale per color. Thus, 14 bits are needed to achieve these fractional values on a binary bus. The 42 bits from the degamma circuit 204 are routed to Blue-Noise Spatial Temporal Multiplexing (“BN STM) circuit 220, which can use dithering to achieve 14 bits per color of effective bit depth resolution on DMD 210, despite the DMD only being loaded with eight “real” bits. Exemplary techniques for blue noise dithering are described in greater detail in U.S. Pat. Nos. 5,111,310 and 5,341,228. Eight “real” bits means that 256 shades of every color are achieved where the LSB has a weight of 1.0 out of 256 equal-sized color intensity levels. The “real” LSB ‘on’ time is typically 15 us out of 3840 us of on time available for a typical R, G, or B color-band size. (3840 us/15 us=256).

Prior to the BN STM block 220, are RGBW Hue Correction (HC) 206 and Secondary Color Boost/Spoke Light Recapture (SCB/SLR) 208 blocks. The RGBW HC block 206 creates an 8-bit “W” bus that can be used to define gray shades for use by SLR in the subsequent block. The RGBW HC block 206 subtracts data as needed from each R, G, and B 14-bit busses, to correct any hue errors that are created when the W bus data is applied to DMD 210 via the spokes and W segment. SCB/SLR block 208 takes the RGB and W bus data and then creates 16 spoke bits (4 spoke bits for each of the 4 spokes). The 8 W bits that are input to the SCB/SLR block 208 are processed by SLR function and then output as 8 new W bits, which are generated so that they work with the Spoke bits to create the shades of gray needed on DMD 210. SCB/SLR block 208 includes an Spoke Light Recapture (“SLR”) function, which in turn includes the Spoke Hue Trim (SHT) feature. The SHT feature alters the values on the RGB busses by adding or subtracting small values to correct any small hue and/or intensity errors generated when the SLR function creates the 8-bit W bus and 16 spoke bits. The functions of RGBW HC block 206 and SCB/SLR block 208 are described in greater detail in commonly owned U.S. Pat. No. 6,324,006, which is hereby incorporated by reference in its entirety herein.

A BN STM circuit 220 passes through it, unaltered, the W bus and Spoke bits. The 42 bits of RGB data are processed in this circuit and the LSBs are dithered as needed to create additional color shades. Several of the 42 bits output from the BN STM block 220 are STM LSBs for each color. The 42 bits of RGB, the 8 bits of W, and the 16 spoke bits are all input to a noise-free boundary dispersion block 225. A non-binary RAM look-up exists within Boundary Dispersion block 225 that expands the RGB non-LSB inputs. This expansion includes the remapping of these bits into non-binary numbers. The boundary dispersion circuitry can dither these non-LSBs to reduce PWM Temporal Contouring artifacts.

Boundary dispersion block 225 has in this embodiment a total of 81 output bits comprised of 57 RGB bits, 8 W bits, and 16 Spoke bits. These 81 bits are input to a bit plane mux 230, although not all of these bits can be displayed on DMD 210. The bits used depends on the color wheel segment sizes and spoke sizes. Bigger segments have more bit-planes for that color. Similarly, bigger spokes have more spoke bits. Bit plane mux 230 can be configured in firmware, which can be read from FLASH 232 at power-up. The firmware can select bit-plane input bits to be used in a particular system configuration according to the values stored in bit-plane selection registers 234. For example, of the 81 input bits available, only 50 might be used in a typical system. In other more challenging systems, up to 64 bits can be used.

A corner turn buffer 236 and a DRAM read buffer 238 transmit and receive data to and from an external DRAM 240 used for storing bit-planes of information. DRAM read buffer 238 is read to load data onto DMD 210 under control of a phased-reset sequencer 250. Phased-reset sequencer 250 also issues reset commands to a DMD reset block waveform driver 255. Thus, sequencer 250 supervises the loading of each DMD reset block and then resets this block. A clock dropping block 256 is used to optimally fit the PWM sequence time duration into a frame time without overshooting or undershooting the end of the frame time. A pixel cluster histograms circuit 260 monitors the 42 bit (14 bits per color) output of the degamma tables 204. Pixel cluster histogram circuit 260 uses histogram bins, which are used to form cluster counts that a microprocessor (“uP”) 270 monitors. Based on the cluster count results, uP 270 determines sequences best suited for the image being displayed.

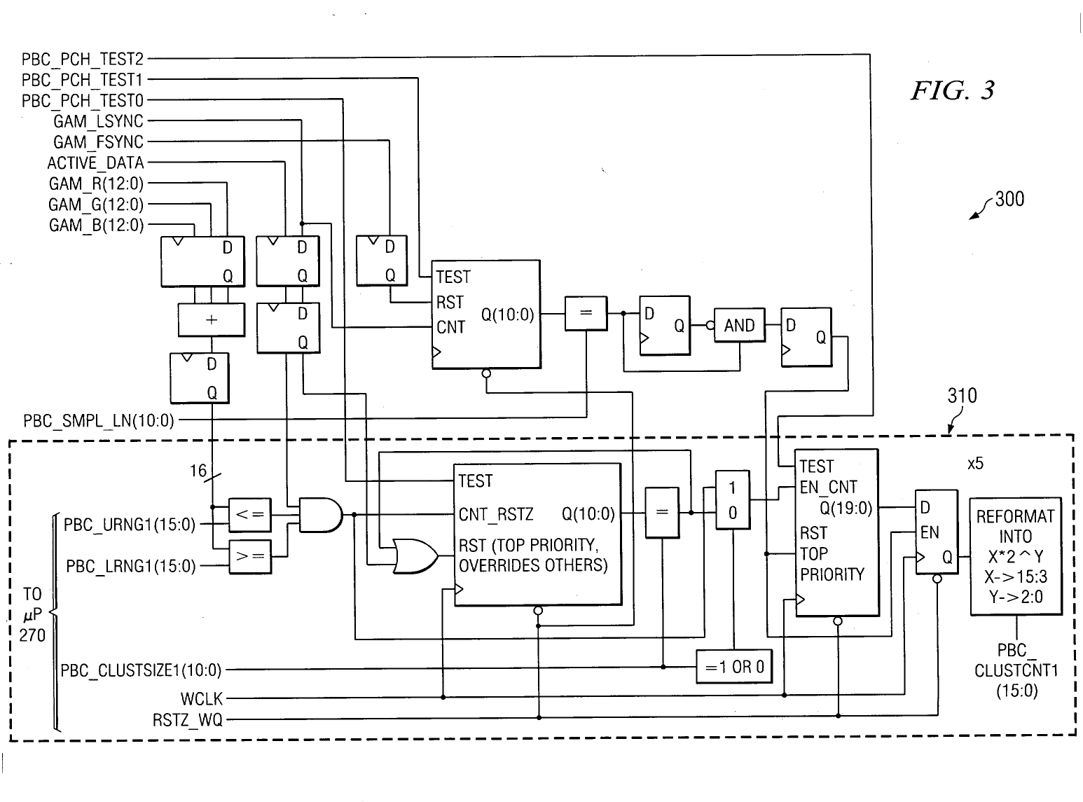

FIG. 3 illustrates an exemplary pixel histogram circuitry 300 configured to count pixels within a certain value ranges and report back to the uP 270 to process the results according to an embodiment of the present invention. Pixel histogram circuitry 300 is an exemplary detailed block diagram of pixel cluster histogram circuitry shown in FIG. 2. Pixel histogram circuitry 300 is configured to monitor the images being displayed and to change the reset mode being employed for the updating of pixel values in the display system according to an embodiment of the present invention.

In the present example, pixel histogram circuitry 300 comprises five different accumulators 310, each configured to count the number of pixels within certain ranges. However, one skilled in the art will appreciate that pixel histogram 300 can include any number of accumulators required to count a given number of pixels established to represent ‘on’ and ‘off’ thresholds of an image. For each of the histogram ranges, the accumulator 310 counts all the pixels within the accumulator's set range, resetting the count on each frame start. To enable realtime selection of the modulation reset sequence based on these histograms, pixel histogram circuitry 300 samples and holds the count during the period between the end of a frame and before the frame sync that signifies the beginning of the next frame.

The count can be captured anytime during the image processing to provide required time for the processor to determine appropriate PWM sequence. For example, in some embodiments, the count is captured after the last line of the current frame processing so that the processor can select appropriate PWM sequence before processing the next frame. Similarly, for slower processors, the count can be captured after the next-to-last line or other late line in the frame when more processing time is needed. Conventionally, this type of information is provided to uP 270 on a frame sync boundary, which adds a pipe delay to the information. However, in an embodiment of the present invention, the updates occur at the end of a frame, but before the frame sync of the next frame. By updating the information before the frame sync of the next frame, a frame of latency can be removed from the process, which enables real-time control of modulation (e.g., PWM) sequencing.

Effectively, as data is fed into the image frame buffer, it is analyzed by pixel histogram circuit 300 which determines the nature of the frame (B/W or not), then between the writing of the last line of a first frame and the beginning of the reading of the first line of data (from the frame buffer) of the first frame, uP 270 selects a sequence based on the nature of the current frame (the first frame) in the buffer and applies results to the read side buffer control sequencer. Conventionally, the sequence selection is applied to a second frame following the first frame (i.e. measure frame 1, apply new sequence to frame 2). When a scene changes from, for example, full black to a normal image, this one frame delay can cause one frame of corrupted image to be displayed, which is generally unacceptable. The flexible sample point of pixel cluster histogram 300 solves this problem by allowing time for all processing at the end of frame 1 rather than the beginning of frame 2.

According to an embodiment of the present invention, a color sequence of one bit per color is used. The one-bit-per-color sequence is used for the entire color time in a frame as well as the spoke time (for single DMD system configurations) in that frame. Thus, 3 bits total are needed where each bit covers one color and its spoke time. In a black and white image, it is possible to use only one bit of all colors and spokes. For example, the green MSB can also be used for displaying the red and the blue. This can be done because if a pixel is determined to be white in a Black and White Image Boost (BWIB) mode, then all three colors must be at full scale. So all three colors are in the same state for this application to be activated in BWIB mode. Given that 14 bits are used in this application for each color, the histogram detection circuitry preferably tests 14 bits at a time.

FIG. 4 is a diagram illustrating exemplary trigger points at which the reduced resets can be enabled or disabled according to an embodiment of the present invention. FIG. 4A illustrates the “on” thresholds, FIG. 4B illustrates the “off” thresholds, and the corresponding histogram bins are shown in FIG. 4C. In the present example, the four separate thresholds drive a total of five histogram bins as shown in FIG. 4C. The histograms in this embodiment consist of upper and lower thresholds that can be set to full-scale black, a few counts above full-scale black, substantially black (based on predetermined criteria), full-scale white, a few counts below full-scale white, substantially white (based on predetermined criteria) and the like, as shown by the exemplary trigger points illustrated in FIGS. 4A and 4B. These thresholds can be set according to the image processing employed in the system.

In the present example, hysteresis is implemented. Various types of hysteresis can be implemented. In data-based hysteresis, the “on” triggers can be set wider than the “off” triggers, such that once the adaptive reset approach has been triggered, it takes more non-black/white pixels to turn it “off” again relative to when it was initially turned on. It is also possible to use time-dependent hysteresis whereby when an image is detected which activates BWIB mode. The BWIB mode can be activated using a predetermined or programmed time delay. According to an embodiment of the present invention, the BWIB mode is turned on after the time interval specified by a ‘Time Until Adaptive Enable” register. When an image is detected which deactivates BWIB mode, it is turned off after the time interval passes specified by a “Time Until Adaptive Disable” register. For purposes of illustration, specific registers are described as including the relevant triggers, however the threshold triggers can be identified using various techniques known in the art. Typically, the “Time Until Adaptive Disable” register may be set to zero, so that an image that changes, can immediately use the full bit depth sequence as described above. The “Time Until Adaptive Enable” register can be set to a non-zero value to prevent erratic turning on of the BWIB mode if a momentary frame event occurred in the source image sequence that might otherwise trip on the BWIB mode and cause the image to briefly go to all black and white pixels.

The above embodiments were described primarily in terms of adaptive sequencing for near full black-and-white images. It is also possible, however, to readily adapt the above circuitry to increase the contrast ratio and brightness of gray-scale and color images. For color images, color sequences represent the manner in which intensity values for each pixel in the color image are processed in a digital display system. Each pixel of a color image is represented by a color sequence (intensity value or pixel code) for each of the primary colors. For example, a pixel will have an intensity value for each of the primary colors, Red, Green, and Blue (“RGB”). A pixel within an 8-bit color sequence can have 256 shades of each color (i.e., 256 possible pixel codes). For example, in a display system, a pixel may have an 8-bit RGB color sequence or pixel codes of (127, 127, 127), which would mean that each of the primary colors was enabled for that particular pixel at one-half of its maximum intensity. Since equal amounts of red, green, and blue create white in an additive display system, the pixel could also be considered to have a white intensity value of 127. Similarly, various pixel code combinations are possible (e.g., white, gray, black, color and the like).

Typically, color images with color sequence of 8 bits per color are loaded into the DMD where one or more of the LSBs of the 8-bits color sequence are used for specialized timing operations to achieve the needed LSB “on” times as described above. According to an embodiment of the present invention, a high quality color image can be made with a color sequence of less than 8 bits per color. For example, a color sequence with 7 bits per color can make typical PC images that are indiscernible from 8 bits per color images except for in areas of images with very much darker code content.

According to an embodiment of the present invention, it is possible to detect whether a color image includes patches of pixels with darker color codes (pixel codes), and if it does not, then the DMD modulation sequence can be switched to a color sequence with reduced color bit-depth (fewer bits of pixel codes). In an embodiment, a histogram of pixels is taken over localized regions on the DMD to look for patches of pixels with dark color codes (pixel codes). If no patches of dark color codes are found, then the reduced bit-depth color sequence can be activated. The pixels cluster histogram system 300 described in FIG. 3 counts the number of adjacent pixels in a horizontal line that have pixel codes between certain programmable range.

One of the counters can count the number of pixels that fall in the various histogram ranges. These ranges can be programmed in the system. Each time a programmable number of contiguous pixels occur that fall between these ranges, then these pixels are flagged as a “cluster” or group. The number of pixels that fall between a programmable range for each group can be selected from a given range for example, certain percentage can be defined (e.g., 95%, 98%, 99.9% or the like of a programmable threshold) to determine whether a ‘cluster’ has been detected. One skilled in the art will appreciate that any combination of the number of pixels in a group, number of groups in one frame, programmable range of pixel codes or the like of a given frame of an image can be selected base on the image processing application to determine the modulation sequence for the frame. Each time a cluster is detected, the pixel counter is cleared and a second counter, the cluster counter (group counter) can count the number of clusters over the frame time. For purposes of illustration, in the present example, the clusters of pixels are identified using horizontally adjacent pixels, the clusters can be identified using vertically and diagonally adjacent pixels or a combination thereof.

If the number of clusters (groups of pixels) exceed a programmable number in the given frame, then the color image is considered to need default color sequence representation (e.g., 8-bit color or the like) for processing, and no changes are made to the normal sequence. However, if the number of clusters (groups of pixels) fall below the programmable number, then an alternate color sequence (e.g., 7-bit color sequence or the like) can be selected for the pixels and the image can increase in brightness and contrast. Similarly, the selection of alternate color sequence can be based on the number of pixels in clusters (groups). One skilled in the art will appreciate that various combinations of pixel codes, pixels groups, image type (e.g., video, graphics, or the like) are possible to determine the need for alternate modulation sequence for a given frame or image. At VSYNC (at the end of each frame), all the counters are cleared and the process of identifying and counting the clusters starts over. The number of clusters can be chosen according to the quality desired for the displayed image.

The circuit described above can be replicated several times to create multiple channels so that dark areas in images can be detected for adjacent pixels (e.g., horizontally, vertically or diagonally adjacent pixels or the like) that have color shade codes very near to each other (e.g., within a predefined range of color shade codes or the like). Each channel can count pixels as being in a dark code cluster for pixels that have color shade codes very near to each other. Each channel monitors pixels for a bin of dark codes; thus each channel can evaluate pixels in different ranges. Multiple channels can be used, because in dark areas of scenes, image details are lost only if codes are missing that are very near to codes in a contiguous localized patch of pixels in the image. If codes in a localized area take big code jumps, then it doesn't matter if the sequence is original or alternate (e.g., 8-bits color versus 7-bits color or the like). No spatial contouring of the image will be noticeable in this instance because the detail will not be very fine. To attain the resolution to distinguish if a cluster has codes very near each other, multiple channels are used with these embodiments. Each channel can be programmed to monitor clusters in different dark code ranges.

In the present example, dropping from a color sequence with 8-bits/color to a color sequence with 7-bits/color has the benefits above for dealing with Reset and Release and Fast Clear LSBs. However, in some systems more than one of these bit types are used per color. In such cases it is also possible to go from a color sequence of 8-bits/color to a color sequence of 6-bits/color or the system could go from a color sequence of 8-bits/color to color sequence of 7-bits/color for some colors (e.g., green and red) and a color sequence of 6-bits/color for another color (e.g., blue) or various combinations thereof.

Similarly, if the image source has more input bits (e.g., 10-bits/color or the like), then the color representation of the alternate sequence can be dropped to any number of low bit color representation (e.g., from 10-bits/color to 8-bits/color or the like or a different combination thereof). Various bit reduction variations are possible. The bit reduction can go from the number of inputs (e.g., 10 bits/color sequence or 30 total bits) down to 1 bit for all colors in the case of a black-and-white image, or the bit depth can be reduced to any number of bits in-between.

The Pixel Cluster Histogram block 300 provides system software with a frame-by-frame histogram of pixel “cluster” counts over various programmable ranges (e.g., 6, 8, 10, 12 or the like). Pixel cluster histogram block 300 determines the degree of low-level contours in a given frame so that the system software can properly select a sequence that has the correct trade-off between low level dither versus noise performance. For purposes of illustration, in the present example, eight sets of minimum/maximum range values are used. The histogram processing begins by adding RGB components and comparing the resulting value (on a pixel-by-pixel basis) with eight sets of minimum/maximum range values (five independent histogram ranges). If the pixel sum value is between the min/max limits for a given range, the pixel counter for that segment is incremented. When the value of this counter matches a software controllable parameter, the counter is reset and another counter—the cluster counter—is incremented. The pixel counter resets to zero on both FSYNC and HSYNC, and when the count reaches a predetermined (programmable) cluster size.

The cluster counter shadow latches its value and resets on FSYNC. The eight cluster counters operate independently, each having its own upper/lower limits and cluster size parameters. Cluster count values are available to the after FSYNC. The values are held constant until immediately after FSYNC. Any number of counters can be used to measure pixel clusters on the display according to system design goals. By analyzing the resulting cluster count values over several frames, system software can determine the type of image source (e.g., an image with a significant number of low-level contours, a graphics screen, test pattern with a relatively small number of clustered low-level gray shades or the like). Upon such determination, the system can appropriately switch to a sequence that does not use reset and release bits. Removing reset and releases from the bit sequences can increase both lumens and contrast ratio.

Pixel cluster histogram (“PCH”) block 300 can also be used for contrast ratio expansion during black and white images. One of the histograms can be set up to look for pixel clusters that are not substantially black (dark) or substantially white (light). If no nonwhite/black pixels are detected, the bit selection sequence can be switched to a single hanging MSB bit. By reducing the number of mirror resets from approximately 60 to 1, the black level can be significantly “blacker” than would typically be achievable. Also, the white level can be slightly brighter (e.g., −0.5% or the like). To apply the correct sequence to a given frame, the new sequence is selected before the frame is complete. For this purpose, the PCH block is sampled on a line near the bottom of the image that allows the histograms to have the most current frame information while still providing the processor enough time to change sequences prior to the next vertical sync period.

A few preferred embodiments have been described in detail hereinabove. It is to be understood that the scope of the invention also comprehends embodiments different from those described, yet within the scope of the claims. Words of inclusion are to be interpreted as nonexhaustive in considering the scope of the invention. While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

While particular embodiments of the present invention have been shown and described, it will be clear to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of processing an image, the image including a sequence of frames of pixels, the method comprising:
determining numbers of substantially dark and substantially light pixels for at least one frame of the sequence of frames; and
selecting a modulation sequence for the at least one frame based at least partially on the numbers of substantially dark and substantially light pixels in the at least one frame.

2. The method of claim 1, wherein the numbers of substantially dark and substantially light pixels are determined using a histogram of the intensities of the pixels in the at least one frame.

3. The method of claim 1, wherein the modulation sequence is selected based at least in part on the cumulative number of both substantially dark and substantially light pixels in the at least one frame.

4. The method of claim 1, wherein the modulation sequence is selected based at least in part on the separate numbers of substantially dark and substantially light pixels in the at least one frame.

5. The method of claim 1, wherein the modulation sequence is pulse-width modulation.

6. The method of claim 1, wherein the modulation sequence comprises a pixel value update per frame.

7. The method of claim 1, wherein the modulation sequence comprises multiple pixel value updates per frame.

8. The method of claim 1, wherein the modulation sequence for the at least one frame is selected prior to processing another frame in the sequence of frames, based at least partially on the numbers of substantially dark and substantially light pixels in the at least one frame, wherein the another frame immediately follows the at least one frame in the sequence of frames.

9. The method of claim 1, wherein the at least one frame is one of a plurality of frames, wherein the modulation sequence is selected for the plurality of frames based at least partially on the numbers of substantially dark and substantially light pixels in the plurality of frames, and wherein the modulation sequence is used for processing at least the first frame of the plurality of frames.

10. The method of claim 1, wherein the modulation sequence for the at least one frame is selected based at least partially on a predetermined number of substantially white and substantially black pixels in the at least one frame.

11. The method of claim 1, further comprising, upon determining the numbers of substantially black and substantially white pixels in the at least one frame, delaying the selection of the modulation sequence for a predetermined period.

12. The method of claim 1, wherein the image is a video image.

13. The method of claim 1, wherein the image is a graphics image.

14. The method of claim 1, wherein the image is a gray-scale image.

15. The method of claim 1, wherein the image is a color image.

16. A method of processing an image, the image including at least one frame of pixels, wherein a first color sequence is an initial color sequence used for processing the image, the method comprising:
determining groups of one or more adjacent pixels in the at least one frame, wherein substantially all of the pixels within each group has a pixel code falling within a range of pixel codes; and
selecting a second color sequence for processing the at least one frame based at least partially on groups of one or more adjacent pixels in the at least one frame.

17. The method of claim 16, wherein the second color sequence is selected for processing the at least one frame if the number of groups of one or more adjacent pixels in the at least one frame is fewer than a predetermined number.

18. The method of claim 16, wherein the second color sequence is selected for processing the at least one frame if the determined groups of one or more adjacent pixels include a predetermined number of pixels.

19. The method of claim 16, wherein the pixel code defines a color shade of an associated pixel in the frame.

20. The method of claim 16, wherein number of adjacent pixels in each group is predetermined.

21. The method of claim 16, wherein the adjacent pixels in the respective groups are one or more of horizontally, vertically and diagonally adjacent pixels.

22. The method of claim 16, wherein the pixel codes used in the second color sequence comprise at least one bit fewer than the pixel codes used in the first color sequence.

23. The method of claim 16, wherein eight-bit pixel codes are used to represent the pixels in the first color sequence.

24. The method of claim 23, wherein the pixels in the second color sequence are represented by seven bits or fewer.

25. The method of claim 16, wherein the image is a video image.

26. The method of claim 16, wherein the image is a graphics image.

27. The method of claim 16, wherein the range of pixel codes represents a color associated with the pixel codes.

28. An apparatus comprising:
at least one pixel histogram unit configured to determine numbers of substantially dark and substantially light pixels for at least one frame of a sequence of frames; and
at least one processor coupled to the pixel histogram unit and configured to select a modulation sequence for the at least one frame based at least partially on the numbers of substantially dark and substantially light pixels in the at least one frame.

29. The apparatus of claim 28, wherein the processor is further configured to select the modulation sequence for the at least one frame prior to processing another frame in the sequence of frames, based at least partially on the numbers of substantially dark and substantially light pixels in the at least one frame, wherein the another frame immediately follows the at least one frame in the sequence of frames.

30. The apparatus of claim 28, wherein the processor is further configured to
select the modulation sequence based at least in part on the separate numbers of substantially dark and substantially light pixels in the at least one frame.

31. The apparatus of claim 28, wherein the at least one frame is one of a plurality of frames, wherein the processor is further configured to select the modulation sequence for the plurality of frames based at least partially on the numbers of substantially dark and substantially light pixels in the plurality of frames, and wherein the modulation sequence is used for processing at least the first frame of the plurality of frames.

32. The apparatus of claim 28, wherein the processor is further configured to
upon determining the numbers of substantially black and substantially white pixels in the at least one frame, delay the selection of the modulation sequence for a predetermined period.

33. The apparatus of claim 28, wherein the the pixel histogram unit is further configured to determine the numbers of substantially dark and substantially light pixels using a histogram of the intensities of the pixels in the at least one frame.

34. The apparatus of claim 28, wherein the modulation sequence is pulse-width modulation.

35. The apparatus of claim 28, wherein the modulation sequence comprises a pixel value update per frame.

36. The apparatus of claim 28, wherein the modulation sequence comprises multiple pixel value updates per frame.

37. The apparatus of claim 28, wherein the processor is further configured to select the modulation sequence for the at least one frame based at least partially on a predetermined number of substantially white and substantially black pixels in the at least one frame.

38. The apparatus of claim 28, wherein the image is a video image.

39. The apparatus of claim 28, wherein the image is a graphics image.

40. The apparatus of claim 28, wherein the image is a gray-scale image.

41. The apparatus of claim 28, wherein the image is a color image.

42. An apparatus comprising:
at least one pixel cluster histogram unit configured to determine groups of one or more adjacent pixels in the at least one frame, wherein substantially all of the pixels within each group has a pixel code falling within a range of pixel codes, and the at least one frame of pixels, wherein a first color sequence is an initial color sequence used for processing an image including the at least one frame; and
at least one processor coupled to the pixel cluster histogram unit and configured to select a second color sequence for the at least one frame based at least partially on groups of one or more adjacent pixels in the at least one frame.

43. The apparatus of claim 42, wherein the processor is further configured to
select the second color sequence for processing the at least one frame if the number of groups of one or more adjacent pixels in the at least one frame is fewer than a predetermined number.

44. The apparatus of claim 42, wherein the processor is configured to
select the second color sequence for processing the at least one frame if the determined groups of one or more adjacent pixels include a predetermined number of pixels.

45. The apparatus of claim 42, wherein the pixel code defines a color shade of an associated pixel in the frame.

46. The apparatus of claim 42, wherein number of adjacent pixels in each group is predetermined.

47. The apparatus of claim 42, wherein the adjacent pixels in the respective groups are one or more of horizontally, vertically and diagonally adjacent pixels.

48. The apparatus of claim 42, wherein the pixel codes used in the second color sequence comprise at least one bit fewer than the pixel codes used in the first color sequence.

49. The apparatus of claim 42, wherein eight-bit pixel codes are used to represent the pixels in the first color sequence.

50. The apparatus of claim 49, wherein the pixels in the second color sequence are represented by seven bits or fewer.

51. The apparatus of claim 42, wherein the image is a video image.

52. The apparatus of claim 42, wherein the image is a graphics image.

53. The apparatus of claim 42, wherein the range of pixel codes represents a color associated with the pixel codes.
